(19) United States
(12) Patent Application Publication
(10) Pub. No.: US 2009/0173071 A1
(43) Pub. Date: Jul. 9, 2009

(54) Diesel engine with exhaust gas recirculation system

(76) Inventor: Davorin Kapich, Carlsbad, CA (US)

Correspondence Address: John R. Ross, PO Box 2138, Del Mar, CA, 92014, US

(21) Appl. No.: 12/006,975

(22) Filed: Jan. 7, 2008

(51) Int. Cl. F02M 25/07; F02B 33/44; F02B 33/40

(52) U.S. Cl. 60/605.2; 123/568.12; 123/565

(57) ABSTRACT

A diesel engine with an exhaust gas recirculation system. The diesel engine is equipped with a turbocharger, driven by exhaust gas from the engine combustion chamber, providing an intake air flow and an inter-cooler for cooling the intake air compressed by the turbocharger. The exhaust gas recirculation system includes an exhaust gas diverter for diverting a portion of the exhaust gas for recirculation back into the combustion chamber. The diverted exhaust gas is cooled and then forced, with a hydraulic turbine driven blower, into the flow of compressed intake air exiting the inter-cooler. The mixture of compressed intake air and the re-circulated exhaust gas is then directed into the intake manifold of the engine then into the engine combustion chamber. The hydraulic turbine driven blower is driven with high-pressure hydraulic fluid provided by a hydraulic pump driven by the engine drive shaft. A hydraulic bypass system with a bypass control valve permits control of the hydraulic turbine by partial or complete bypassing of the hydraulic turbine. The re-circulated exhaust gas may be cooled with radiator water. In preferred embodiments the exhaust gas is cooled with three stages of air cooling. Cooling of the first stage cooler is provided by a portion of the turbocharger compressed air which than provides driving power to the turbo-fan turbine that drives the cooling fan and supplies cooling air flow to the second and third stage EGR coolers. Optionally, the air to air after-cooler is removed from the front of the engine location and included into the overall EGR—after-cooler turbo-fan air cooled package.

The present invention relates to diesel engines and in particular to diesel engines requiring exhaust gas recirculation systems.

### BACKGROUND OF THE INVENTION

### The 2010 EPA Diesel Engine Regulations

On Dec. 21, 2000, the EPA announced that it had finalized new rules, under the Clean Air Act, to reduce emissions of nitrogen oxides (NOₓ) and sulfur oxides (SOₓ) that result from the use of diesel fuels. Specifically, the EPA regulations aim to reduce air pollution from diesel vehicles by controlling two things: vehicle emissions (primarily NOₓ, particulate matter, and hydrocarbons) and the sulfur content of diesel fuel. Particulate emissions will be limited to 0.01 grams per brake-horsepower-hour (g/bhp-h), a 90% reduction compared with 1980s engines; NOₓ emissions will be limited to 0.20 g/bhp-h (corresponding to a 95% reduction). By the year 2030, the EPA estimates that this will effectively reduce the annual emission of NOₓ gases by 2.6 million tons, and particulate matter by 109,000 tons. Further, emission of nonmethane hydrocarbons (NMHC) will also be limited to 0.14 g/bhp-h, a reduction of 115,000 tons annually by 2030. The emission limits for NOₓ gases and NMHCs will be phased in based on a percentage of engines, or vehicles, sold. Thus, 50% of new vehicles must meet the lower emission standards between 2007 and 2009, and all engines being produced must meet them by the year 2010.

### Exhaust Gas Recirculation

These regulations of the United States Environmental Protection Agency will by 2010 result in a requirement that exhaust gas recirculation flow rate be increased up to about 30 percent of engine exhaust for most if not all diesel engines. Exhaust gas recirculation is a known technique for reducing nitrogen oxide emissions and is in use today by several major diesel engine manufacturers. These regulations are known as the US-EPA 2010 emissions requirements.

Exhaust gas recirculation involves separating a portion of the gas exhausted from the engine and mixing the exhaust gas with oxygen rich intake air. Due to the fewer oxygen molecules in the mixture the peak temperature and the amount of excess oxygen are reduced which results in less nitrogen oxide formation.

FIG. 1 is a drawing of a prior art exhaust gas recirculation system for reducing the nitrogen oxide emissions from a diesel engine. As shown in the drawing intake air is drawn in through an air filter and compressed with a turbocharger driven by engine exhaust and cooled by air to air intercooler (sometimes referred to as an “after cooler) usually positioned ahead of the engine radiator. A portion such as 20 to 30 percent of the engine exhaust is separated before the exhaust gas reaches the turbocharger and is cooled in a exhaust gas recirculation (EGR) cooler where a portion of the heat is transferred to radiator cooled water. The flow rate of the re-circulated exhaust gas into the engine is controlled by a throttle valve designated as rate control valve in FIG. 1. The compressed intake air is directed through an air to air cooler called an intercooler and mixed with the cooled exhaust gas and the mixture is directed into the engine manifold. The exhaust gas leaving the turbocharger is filtered in a particulate filter and discharged to the atmosphere.

### Prior Art Problems

### Controlling Engine Intake and Exhaust Pressures

A turbocharged diesel engine depends on its turbocharger to maintain intake manifold pressure. The gas recirculation flow rate depends on the pressure difference between exhaust pressure and intake manifold pressure. At different engine operating regimes the pressure difference between engine exhaust manifold and engine intake manifold is often reduced or even reversed due to turbocharger efficiency characteristics and the maintenance of desired engine exhaust to intake manifold pressure differential becomes difficult. Thus, complicated measures have to be taken in attempt to maintain exhaust pressure to intake manifold pressure difference at desired levels. Current method using the rate control valve in FIG. 1 results in throttling of the entire engine charge air flow resulting increased engine pumping losses and increased fuel consumption.

### Cooling the Re-Circulated Exhaust Gas

In order to avoid substantial reduction in engine performance associated with exhaust gas recirculation, the exhaust gas that is re-circulated should be cooled to about 180 degrees C. A typical exhaust gas recirculation mass flow rate for a typical heavy duty on-highway diesel engine is approximately 700 kg/hr. This means the heat rejection through the exhaust gas recirculation cooler into the engine coolant may be approximately 100 kW. Therefore, the vehicle radiator has to be adjusted to satisfy this significantly increased heat rejection requirement. This requires large increase in the cooling capacity of the engine cooling system that includes larger coolant pump, larger radiator and larger radiator fan. Cooling of exhaust gas recirculation flow requires more power for the engine coolant pump and the radiator fan. Eliminating the exhaust gas recirculation heat load from the engine standard cooling system for a typical heavy duty on-highway diesel engine would produce an estimated saving of about 12 to 18 engine horsepower.

### Applicant's Prior Art Patents

Applicant has developed and patented high performance hydraulic turbine powered supercharger systems and systems for the improvement of performance of internal combustion engines including diesel engines. His patents include: U.S. Pat. No. 5,924,286 “Hydraulic Supercharger System”, U.S. Pat. No. 5,275,533, “Quiet compressed air turbine fan”, U.S. Pat. No. 5,427,508 “Electro-pneumatic blower” and U.S. Pat. No. 6,502,398, “Exhaust Power Recovery System”. These patents are hereby incorporated herein by reference.

What is needed is an efficient compact exhaust gas recirculation system that will permit diesel engine manufacturers to meet the US-EPA 2010 emission requirements while achieving high power density of diesel engines while decreasing (or at least not increasing) fuel consumption.

### SUMMARY OF THE INVENTION

The present invention provides a diesel engine with an exhaust gas recirculation system. The diesel engine is equipped with a turbocharger, driven by engine exhaust gas, providing pressurized intake air flow and an inter-cooler for cooling the intake air compressed by the turbocharger. The exhaust gas recirculation system includes an exhaust gas diverter for diverting a portion of the exhaust gas for recirculation back into the engine intake manifold. The diverted exhaust gas is cooled and then forced, with a hydraulic turbine driven blower, into the flow of compressed intake air exiting the inter-cooler. The mixture of compressed intake air and the re-circulated exhaust gas is then directed into the intake manifold of the engine then into the engine combustion chamber. The hydraulic turbine driven blower is driven with high-pressure hydraulic fluid provided by a hydraulic pump driven by the engine drive shaft. A hydraulic bypass system with a bypass control valve permits control of the hydraulic turbine by partial or complete bypassing of the hydraulic turbine.

A relatively simple first preferred embodiment utilizes a high speed hydraulic turbine driven blower to control the flow of re-circulated exhaust gas into the engine. High pressure hydraulic fluid is provided by a hydraulic pump driven by the engine shaft. In this first embodiment of the present invention the re-circulated exhaust gas is cooled by radiator water. In a second preferred embodiment three stages of exhaust air cooling is provided. Some of the heat energy in the waste heat is used to augment power of the compressed air produced by the turbocharger compressor. That hot compressed air is used to drive a turbine driven cooling fan. No radiator water cooling is needed. This embodiment also utilizes the high speed hydraulic turbine driven recirculation blower feature of the first preferred embodiment. In a third preferred embodiment the air to air intercooler is removed from its usual place in front of the radiator location and is included into the turbine-fan cooled EGR package.

A fourth preferred embodiment combines with a hydraulic turbine assisted turbocharger with the system of the third preferred embodiment. In this fourth preferred embodiment the hydraulic turbine is on the same shaft with the turbocharger. In a fifth preferred embodiment instead of the turbocharger and the hydraulic turbine being on the same shaft, they are separate units operating in series.

The use of the high speed hydraulic turbine driven blower to control the flow of re-circulated exhaust gas into the engine greatly simplifies control of the engine intake air and eliminates engine pumping losses resulted by throttling the entire engine air flow. The air cooling of either of the second, third, fourth or fifth embodiments avoids reliance on radiator water for exhaust gas cooling.

### BRIEF DESCRIPTION OF THE DRAWINGS

FIG. 1 shows a conventional prior art exhaust gas recirculation system as employed in a typical on-highway truck engine.

FIG. 2 shows a relatively simply designed exhaust gas recirculation system utilizing a high speed hydraulic turbine driven blower to control the flow of re-circulated exhaust gas into the engine. In this first embodiment of the present invention the re-circulated exhaust gas is cooled by radiator water as in the prior art system shown in FIG. 1.

FIG. 3 shows an exhaust gas recirculation system with three stages of exhaust air cooling utilizing some of the energy in the waste heat to augment compressed air produced by the turbocharger to drive a turbine driven cooling fan to provide the exhaust air cooling. No radiator water cooling is needed. This embodiment also utilizes the high speed hydraulic turbine driven recirculation blower feature shown in FIG. 2.

FIG. 4 show a system similar to the FIG. 3 system with the air to air intercooler removed from its conventional in front of the radiator location shown in FIG. 3 and included in turbine fan cooled exhaust gas recirculation package.

FIG. 5 shows a system similar to the FIG. 4 system combined with a hydraulic turbine assisted turbocharger.

FIG. 6 shows a system similar to FIG. 4 combined with a hydraulic turbine driven air supercharger in series with engine turbocharger.

FIG. 7 is a prior art drawing of the hydraulic turbine assisted turbocharger from Applicant's U.S. Pat. No. 5,924,286 “Hydraulic Supercharger System”.

FIG. 8 is a drawing of a cooling fan utilizing integral fan-turbine wheel used in preferred embodiments of the present invention.

FIG. 9 is a prior art drawing of a cooling fan utilizing integral fan-turbine wheel from Applicant's U.S. Pat. No. 5,275,533 “Quiet compressed air turbine fan”.

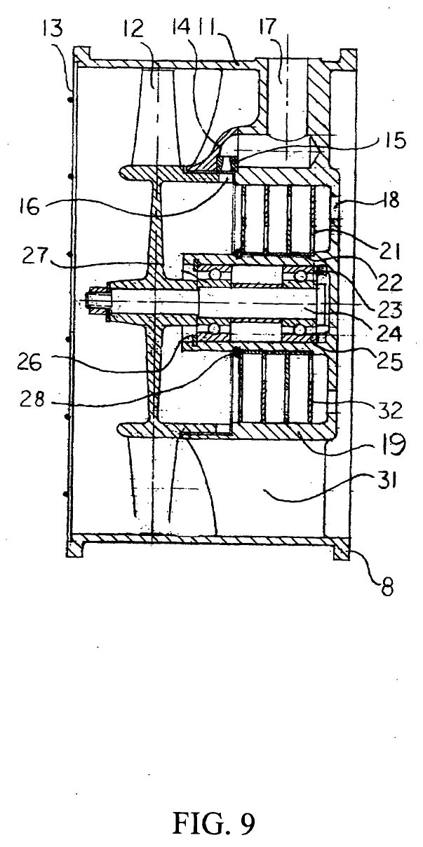

FIG. 10 shows a possible location of the EGR cooling package relative to the conventionally cooled air to air intercooler and engine radiator.

FIG. 11 shows a possible location of the EGR cooling package combined with the air to air intercooler relative to engine and engine radiator.

### DETAILED DESCRIPTION OF PREFERRED EMBODIMENTS

Preferred embodiments of the present invention can be described by reference to the figures.

### Hydraulic Turbine Driven Blower for Controlling Exhaust Gas Flow

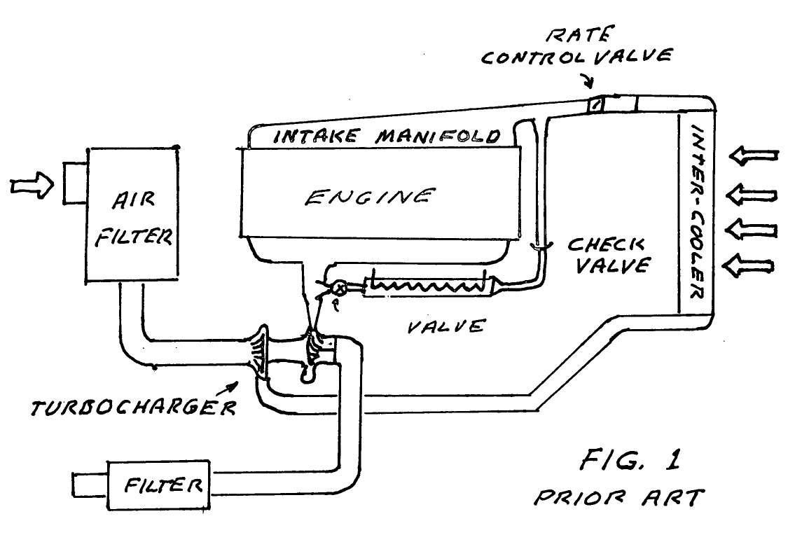

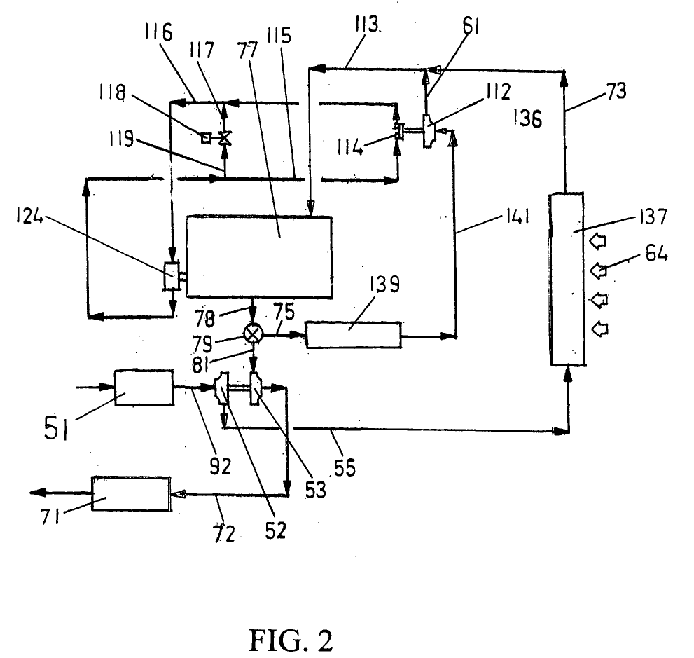

FIG. 2 shows a relatively uncomplicated first preferred embodiment utilizing a high-speed hydraulic turbine driven blower to control the flow of re-circulated exhaust gas into the engine. High pressure hydraulic fluid is provided by a hydraulic pump driven by the engine shaft. In this first embodiment of the present invention the re-circulated exhaust gas is cooled by radiator water. In this embodiment an exhaust gas cooling system for a 11 liter on-highway diesel engine exhaust gas rate control throttle control valve shown in FIG. 1 is replaced with a high-speed blower 112 capable of generating a pressure rise of 5 psid and an exhaust gas flow rate of 21.5 pounds per minute. The blower is driven by high speed hydraulic turbine 114 generating 3.96 HP at 68,500 RPM with hydraulic fluid pressure differential of 1500 psig and having capability of operating at EGR fluid temperatures of up to 500 degrees Fahrenheit. A high efficiency hydraulic pump 124 driven by the drive shaft of engine 77 provides 5.4 gallons per minute flow to the hydraulic drive system which provides high pressure fluid flow to high speed hydraulic turbine 114. Hydraulic control valve 118 can be operated to bypass portions of hydraulic pump 124 flow around the high speed hydraulic turbine 114 as required to maintain required exhaust gas flow generated by high speed blower 112. Exhaust gas flow is further channeled via line 61 into line 113 where it mixes with air flow supplied by turbocharger compressor 52 and cooled by ambient air 64 in the air to air charge air cooler 137 and channeled via line 73 to line 113. Exhaust gas from engine 77 is channeled through exhaust duct 78 and is split by valve 79 into 30 percent exhaust flow channeled by line 75 to radiator water cooled cooler 139 and into high speed blower 112 via line 141. The remaining 70 percent exhaust flow is channeled via line 81 to turbocharger turbine 53 driving turbocharger compressor 52. Exhaust flow is further channeled via line 72 and diesel particulate filter 71 out into atmosphere. The FIG. 2 system eliminates the standard throttle control valve and associated engine pumping losses but does not eliminate losses associated with increased engine coolant load due to additional exhaust gas recovery heat load.

### Addition of Three Stages of Air Cooling of Exhaust Gas

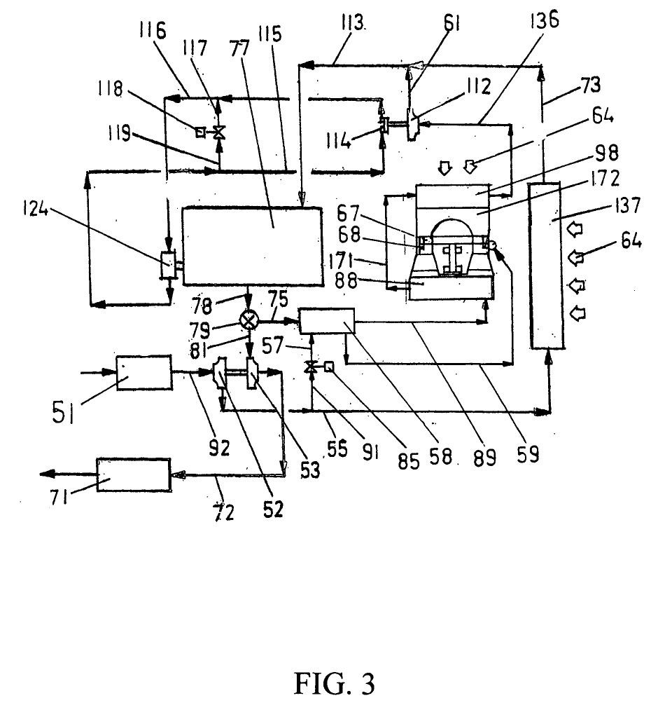

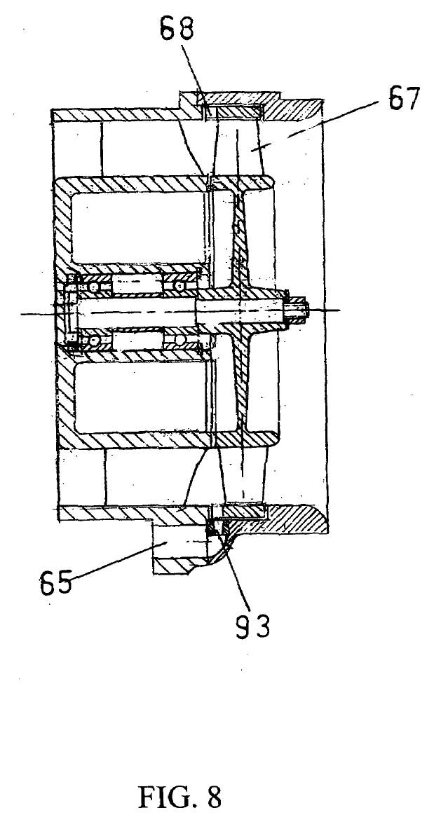

FIG. 3 shows a second preferred embodiment of the present invention. This embodiment represents further improvement of the system described in FIG. 2 with addition of turbo-fan 87 and three coolers 58, 88 and 98. This system eliminates the exhaust gas heat load to engine cooling system that is present in the FIG. 2 embodiment. A turbocharged engine system is combined with an air-cooled EGR cooling system in which a portion of intake air compressed by engine exhaust gas driven turbocharger compressor 52 is heated by exhaust gas and is utilized to drive a turbine-fan 87 for cooling the re-circulated exhaust gas. Approximately 3% of compressed air flowing in line 55 is diverted into line 91 and through bleed air control valve 85 via line 57 into first stage cooler 58 to provide a first stage cooling of the exhaust gas flow flowing from line 75. Heated compressed air is channeled through line 59 into fan-turbine inlet 65 of turbine fan 87 where air is expanded through partial admission nozzles 93 shown in FIG. 8, driving fan-turbine blades 68 which in turn drive fan blades 67. Partial admission nozzles 93 cover approximately 15 percent of the fan-turbine blades 68 circle, thus exposing the rotating fan-turbine blades 68 for only 15 percent of time to high bleed air temperature of approximately 900 degrees F. Average metal temperature of fan-turbine blades 68 is estimated to be in the range of 350 degrees F. which would allow for use of aluminum alloys for the turbine-fan wheel and blades.

Exhaust gas generated by engine 77 is channeled by exhaust line 78 to control valve 79 in which approximately 30 percent of engine exhaust flow is diverted into line 75 and further on into first stage cooler 58. Reminder of the engine exhaust flow is channeled via line 81 into turbocharger turbine wheel 53 and via line 72 through diesel particulate filter 71 into ambient. Partially cooled exhaust gas flow is channeled from first stage cooler 58 via line 89 into second stage cooler 88 where it is cooled further by cooling air flow generated by axial flow fan blades 67. Exhaust gas flow cooled in the second stage cooler 88 is further channeled into third stage cooler 98 and via line 136 into high-speed blower 112 and further on via line 61 into line 113 where it is mixed with engine combustion air channeled via line 73 flowing from air to air after-cooler 137 which is cooled by ambient air 64. Cooled mixture of exhaust gas and engine combustion air is further channeled via line 113 into engine 77.

Fan blades 67 produce a suction pressure in fan inlet cavity 172 that is pulling ambient cooling air 64 through the third stage cooler 98 and pushing slightly heated cooling air further on through the second stage cooler 88. Utilization of ambient air 64 for final cooling of re-circulated exhaust gas flow in the third stage cooler 98 provides lowest possible temperature of the re-circulated exhaust gas.

Second stage cooler 88 and third stage cooler 98 are preferably designed as compact heat exchangers to match high pressure-flow capacity of the high speed turbo-fan blower blades 67. This substantially increases cooling flow velocity through heat exchangers and reduces total volume of the re-circulated exhaust gas cooling system components, thus improving greatly packaging of total exhaust re-circulated gas cooling system on the vehicle.

Substantial decrease in temperature of the flow of the FIG. 3 embodiment over the standard engine coolant cooled flow such as shown in FIG. 1 and FIG. 2 results in lower required percentage of the re-circulated exhaust gas flow to achieve same results in decreasing “in cylinder” nitrous oxide production. Applicant estimates that with FIG. 3 embodiment the EGR flow could be decreased from 30 percent to approximately 20 percent thus additionally increasing the engine efficiency and decreasing the fuel consumption.

Total cost of the FIG. 3 embodiment is estimated to increase cost of the overall engine cooling system by 5 to 10 percent when accounting for decreased size of standard engine cooling system including engine coolant pump and radiator fan. Savings in engine shaft power required to drive larger coolant pump and larger radiator fan is estimated to be approximately 3 percent of the gross engine power which would translate into approximately 3 percent savings in fuel consumption. Savings in fuel consumption would greatly overshadow the increase in engine cooling systems cost of the FIG. 3 embodiment system.

TABLE I
COMPACT HEAT EXCHANGER
PARAMETERS FOR 11 L ENGINE

| | 1^{st} stage | 2^{nd} stage | 3^{rd} stage | |
|---|---|---|---|---|
| | EGR cooler | EGR cooler | EGR cooler | |
| Heat exchanger duty | 6.1 | 62.3 | 16.2 | (kW) |
| EGR mass flow rate | 22 | 22 | 22 | (lb/min) |
| Air cooling flow rate | 1.6 | 75 | 75 | (lb/min) |
| Heat exchanger type | compact - cross flow | | | |
| Heat transfer surface type | staggered fin | | | |
| Heat exchanger | | | | |
| surface to volume ratio | 250 | 250 | 250 | (ft2/ft3) |
| Heat exchanger volume | 1.3 | 9.6 | 4.1 | (Liter) |

Compact cross flow air to air coolers with capability of up to 400 degrees F. temperatures and up to 1000 HP capacity are commercially available from Turbonetics Inc. 2255 Agate Court, Simi Valley, Calif. 93065. High temperature compact cross flow heat exchangers capable of up to 1300 degrees F. made from austenitic stainless steel are available from Ingersoll-Rand Energy Systems, Portsmouth, N.H.

### Reference Book for Heat Exchanger Design

An excellent reference book for design and fabrication of compact heat exchanges of the type needed in the present invention is: COMPACT HEAT EXCHANGERS by W. M. Kays and A. L. LONDON Stanford University, 1958.

TABLE II
TYPICAL EGR TURBO-FAN PARAMETERS
FOR 2 L AND 11 L ENGINES

| | 2 L ENGINE | 11 L ENGINE |
|---|---|---|
| Turbine inlet air temperature (deg. F.) | 950 | 950 |
| Turbine pressure ratio | 2.9 | 2.9 |
| Turbine mass air flow (lb/min) | 0.68 | 1.60 |
| Turbine power (HP) | 1.0 | 2.6 |
| Turbine-Fan speed (rpm) | 28,100 | 16,500 |
| Cooling fan flow (cfm) | 350 | 1100 |
| Cooling fan pressure rise (inches H2O) | 15.6 | 13.3 |
| Turbine-Fan wheel diameter (in) | 4.1 | 6.4 |

| | |
|---|---|
| Fan blades type | NACA 65 SERIES |
| | CASCADE |

### Addition of the Air to Air Intercooler to the Exhaust Gas Recirculation Cooling System

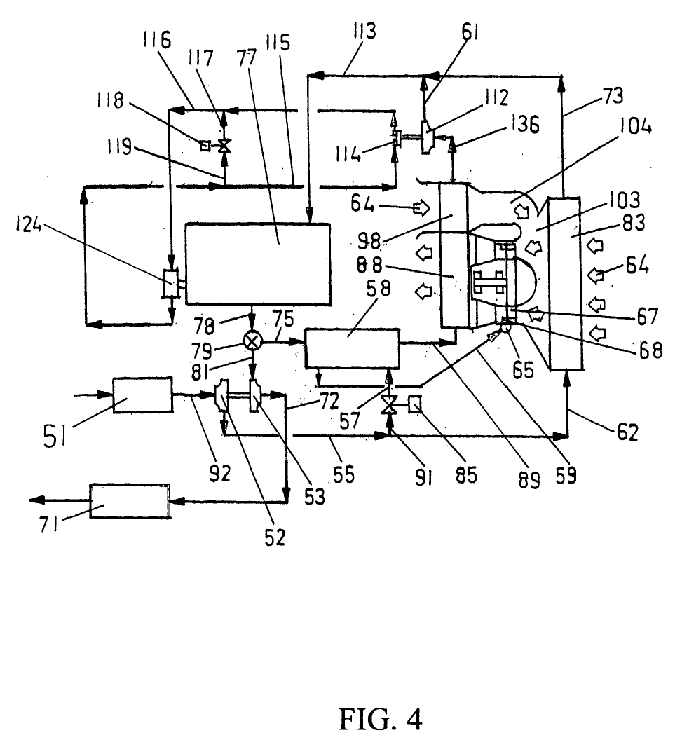

FIG. 4 shows a third preferred embodiment of the present invention. This embodiment is similar to the basic system described in FIG. 3 with exception that standard air to air intercooler shown in FIG. 3 as 137 is being incorporated into turbo fan 87 cooling package shown in FIG. 4. Fan blades 67 produce a suction pressure in the fan inlet cavity 103 and pulling ambient cooling air simultaneously through the air to air after-cooler 83 and via duct 104 through the third stage cooler 98. Partially heated air is forced by the fan blades 67 further on through the second stage cooler 88. The air to air after cooler 83 is preferably designed as compact heat exchanger similarly to the third stage cooler 98 and second stage cooler 88.

### Addition of Hydraulic Turbine on Same Shaft with Turbocharger

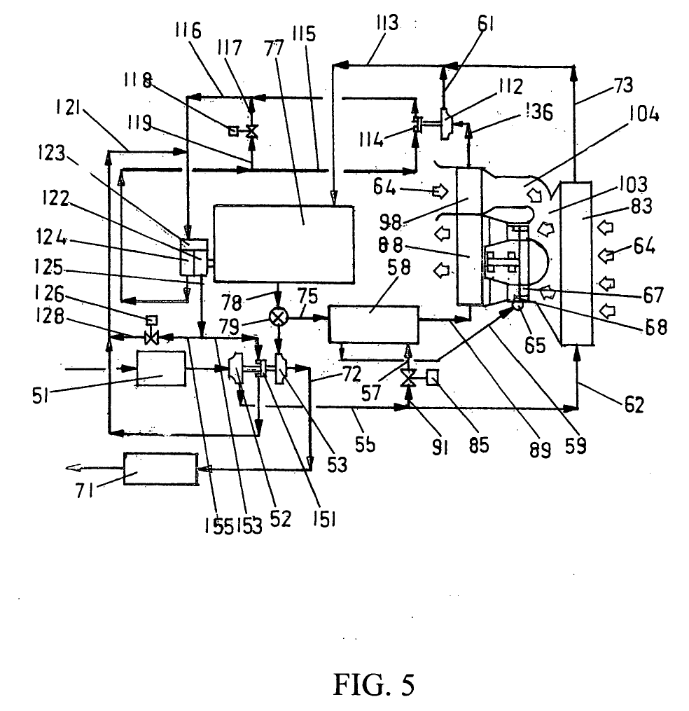

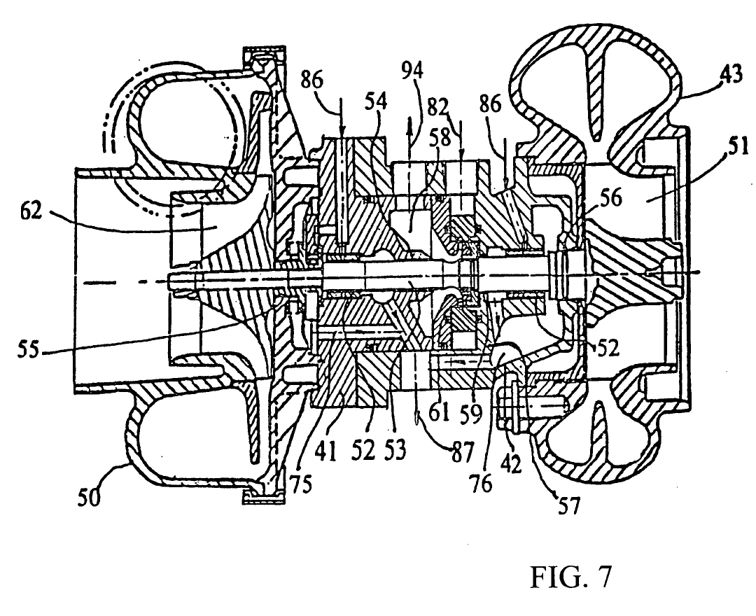

FIG. 5 shows a fourth preferred embodiment of the present invention. This embodiment is the same basic system described in FIG. 4 with addition of a high-speed hydraulic assist turbine 151 assisting turbocharger turbine 53 in driving turbocharger compressor 52 providing additional engine boost when required. FIG. 7 is a drawing of the preferred high speed hydraulic turbine assisted turbocharger design utilizing high efficiency radial in flow hydraulic turbine described in U.S. Pat. No. 5,924,286 (which has been incorporated herein by reference) granted to applicant. FIG. 7 was FIG. 14 in the '286 patent.

The hydraulic system shown in FIG. 5 utilizes single hydraulic pump divided into pump section 124 driving high speed hydraulic turbine 114 and pump section 122 driving high speed hydraulic assist turbine 151. Maximum fluid flow capacity of pump section 124 is approximately 5.4 GPM at 1500 psig maximum discharge pressure and that of pump section 124 is approximately 8 GPM at 2500 psig maximum discharge pressure. Common pump inlet cavity 123 supplies hydraulic flow to pump section 122 and pump section 124. Such double pumps are commercially available as G-5 Series pumps from J. S. Barnes Corporation, Statesville, N.C. Pump section 122 provides 11 GPM flow to the hydraulic drive system which provides high pressure fluid flow to high speed hydraulic assist turbine 151 and to the assist turbine control valve 126 which can bypass portion of hydraulic pump 122 flow around the high speed hydraulic assist turbine 151 as required to maintain boost to the engine 77 generated by turbocharger compressor 53. Hydraulic flow discharged from high speed hydraulic assist turbine 151 joins the hydraulic flow bypassed by the assist turbine control valve 126 via line 128 into line 121 which joins hydraulic flow in line 116 returning from high speed hydraulic EGR turbine 114 and EGR rate hydraulic control valve 118. Power outputs of high speed hydraulic EGR turbine 114 and high speed hydraulic assist turbine 151 are independently controlled of each other by EGR rate hydraulic control valve 118 and assist turbine control valve 126.

### Hydraulic Turbine in Series with Turbocharger

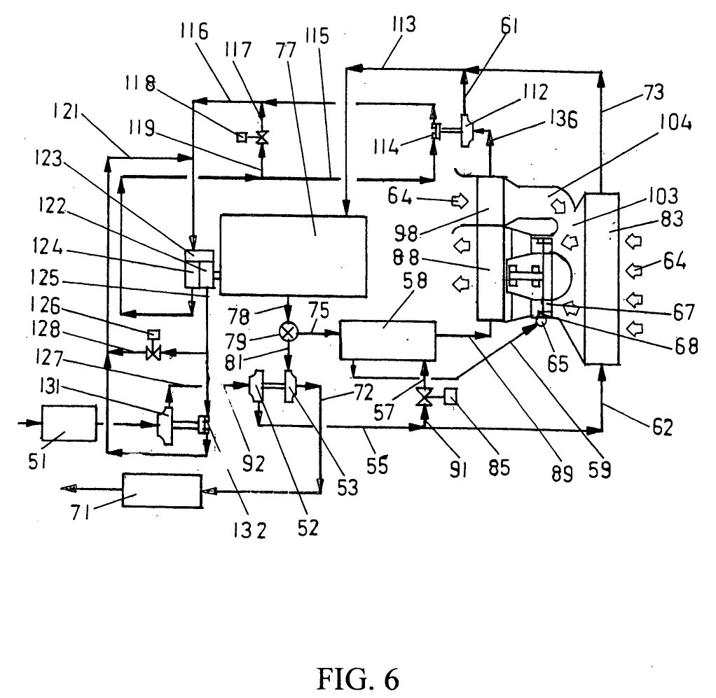

FIG. 6 shows basic system described in FIG. 5 in which high speed hydraulic assist turbine 151 is being replaced by the high speed hydraulic supercharger turbine 132 driving hydraulic supercharger compressor 131 and providing additional boost to the inlet of turbocharger compressor 52 via line 127 when additional engine boost is required. Two-stage compression provided by combining hydraulic supercharger compressor 131 in series with turbocharger compressor 52 is able to generate high boost level over wide operating range of engine

### Heavy Duty On-Highway Truck Installation Requiring Minimum Modification

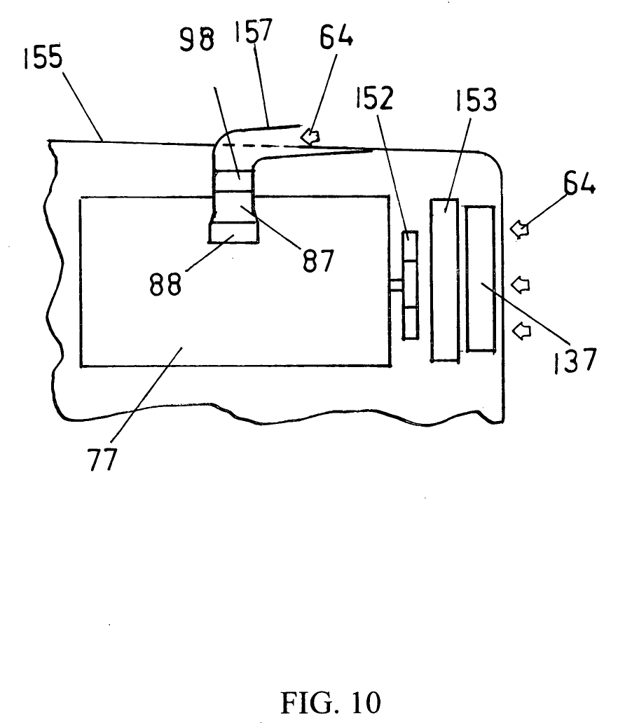

FIG. 10 shows the EGR air cooled package installation requiring minimum truck cooling system modification. As shown in FIG. 3, the EGR air cooled package contains third stage cooler 98, turbo-fan 87 and second stage cooler 88 positioned in separate locations relative to engine radiator 153 and air to air intercooler 137. EGR cooling package can be located in a most desirable location relatively to engine 77. EGR cooling package can also be oriented under any angle relatively to the engine.

### EGR Cooling Package with Air to Air After-Cooler for Heavy Duty On-Highway Truck

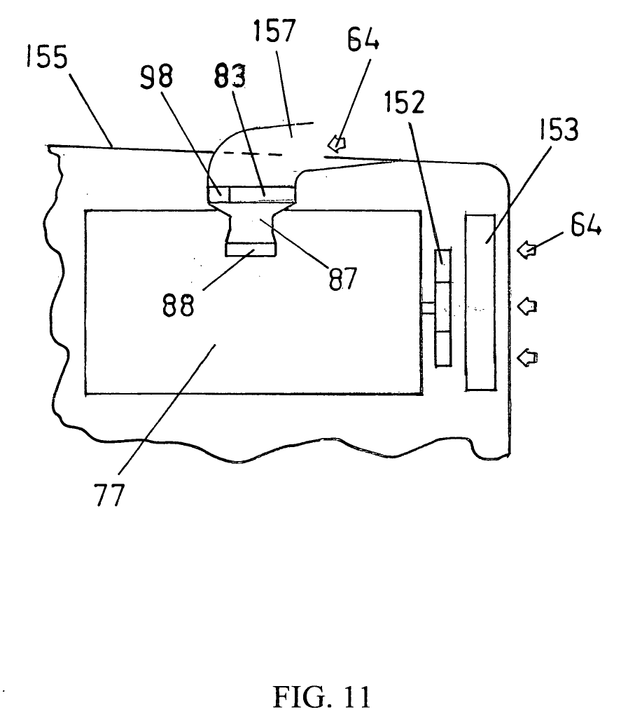

FIG. 11 shows the EGR air cooled installation including the air to air after-cooler, all cooled by the turbo-fan 87 air flow. As shown in FIGS. 4, 5 and 6 the EGR air cooled package contains air to air after-cooler 83, third stage cooler 98, turbo-fan 87 and third stage cooler 88 positioned in separate location relative to engine radiator 153. This air cooled package can be located in a most desirable location relatively to engine 77 and can be oriented under any angle relatively to the engine.

### Variations

The reader should understand that the above descriptions are merely preferred embodiments of the present invention and that many changes could be made without departing from the spirit of the invention. For example the invention can be applied to a great variety and sizes of diesel engines stationary as well as motor vehicle engines. Two (instead of three) stages of air cooling could be utilized which could eliminate either the second stage or the third stage. Many features of Applicants prior art patents that have been incorporated by reference herein could be utilized in connection with the present invention. For all of the above reasons the scope of the present invention should be determined by reference to the appended claims and not limited by the specific embodiments described above.

What is claimed is:

1. A diesel engine with an exhaust gas recovery system comprising:
A) a diesel engine comprising:
1) combustion chamber,
2) a turbocharger, comprising a turbocharger compressor and a turbocharger turbine driven by exhaust gas from the combustion chamber adapted to compress intake air to produce a compressed intake air flow,
3) an inter-cooler for cooling the intake air compressed by the turbocharger,
4) an intake manifold for distributing into the combustion chamber the intake air cooled by the inter-cooler, and
5) an engine drive shaft;
B) an exhaust gas recirculation system for recycling a portion of the engine exhaust gas back into the engine, said exhaust gas recirculation system comprising:
1) an exhaust gas diversion means for diverting a portion of the exhaust gas for recirculation back into the combustion chamber, said portion defining re-circulated exhaust gas,
2) a cooling means for cooling the diverted portion of exhaust gas,
3) a hydraulic turbine driven blower comprising a hydraulic turbine and a blower and adapted to force the diverted portion of exhaust gas into the flow of compressed intake air,
4) a hydraulic pump driven by the engine drive shaft,
5) a hydraulic bypass system with a bypass control valve adapted to permit control of the hydraulic turbine by partial or complete bypassing of the hydraulic turbine;
C) a control system adapted to permit control of the exhaust gas recirculation system utilizing the bypass control valve.

2. The engine as in claim 1 wherein said exhaust gas cooling means comprises a three-stage air cooling system for cooling the re-circulated exhaust gas.

3. The engine as in claim 2 wherein the three-stage air cooling system comprises:
A) a compressed hot air driven turbine fan comprising fan blades, fan turban blades and at least one fan turbine inlet,
B) a first stage comprising an exhaust gas/compressed intake air heat exchanger adapted to transfer heat from said re-circulated exhaust gas to a portion of said compressed turbine intake air flow,
C) diversion piping for diverting said portion of compressed intake air flow through said exhaust gas/compressed intake air heat exchanger to said fan turbine inlet for driving said compressed air driven turbine fan,
D) a second stage comprising an exhaust gas/intercooler air heat exchanger adapted to transfer heat from said re-circulated exhaust gas to inter-cooler exhaust air driven by said turbine fan, and
E) a third stage comprising an exhaust gas/ambient air heat exchanger adapted to transfer heat from said re-circulated exhaust gas to ambient air driven by said turbine fan;
wherein a portion of heat energy from said re-circulated exhaust gas is utilized to help cool the re-circulated exhaust gas.

4. The engine as in claim 3 and further comprising a high-speed hydraulic assist turbine mounted on the shaft of said turbocharger for providing assistance to said turbocharger turbine in driving said turbocharger compressor.

5. The engine as in claim 3 and further comprising a high-speed hydraulic driven supercharger in series with said turbocharger for providing assistance to said turbocharger in compressing said intake air, said high-speed hydraulic driven supercharger comprising a high-speed hydraulic turbine and a compressor driven by said high-speed hydraulic turbine.

6. The engine as in claim 2 wherein the three-stage air cooling system comprises:
A) a compressed hot air driven turbine fan comprising fan blades, fan turban blades and at least one fan turbine inlet,
B) a first stage comprising an exhaust gas/compressed intake air heat exchanger adapted to transfer heat from said re-circulated exhaust gas to a portion of said compressed turbine intake air flow,
C) diversion piping for diverting said portion of compressed intake air flow through said exhaust gas/compressed intake air heat exchanger to said fan turbine inlet for driving said compressed air driven turbine fan, and
D) a second stage comprising an exhaust gas/intercooler air heat exchanger adapted to transfer heat from said re-circulated exhaust gas to inter-cooler exhaust air driven by said turbine fan,
wherein a portion of heat energy from said re-circulated exhaust gas is utilized to help cool the re-circulated exhaust gas.

7. The engine as in claim 2 wherein the three-stage air cooling system comprises:
A) a compressed hot air driven turbine fan comprising fan blades, fan turban blades and at least one fan turbine inlet,
B) a first stage comprising an exhaust gas/compressed intake air heat exchanger adapted to transfer heat from said re-circulated exhaust gas to a portion of said compressed turbine intake air flow,
C) diversion piping for diverting said portion of compressed intake air flow through said exhaust gas/compressed intake air heat exchanger to said fan turbine inlet for driving said compressed air driven turbine fan,
D) a second stage comprising an exhaust gas/ambient air heat exchanger adapted to transfer heat from said re-circulated exhaust gas to ambient air driven by said turbine fan;
wherein a portion of heat energy from said re-circulated exhaust gas is utilized to help cool the re-circulated exhaust gas.

8. The engine as in claim 3 wherein portion of said compressed intake air flow is about 4 percent of said compressed intake air flow.

9. The engine as in claim 3 wherein said fan turbine blades are mounted at or near tips of said fan blades.

10. The engine as in claim 6 wherein said fan turbine blades are mounted at or near tips of said fan blades.

11. The engine as in claim 7 wherein said fan turbine blades are mounted at or near tips of said fan blades.
